(19) United States
(12) Patent Application Publication
(10) Pub. No.: US 2010/0266750 A1
(43) Pub. Date: Oct. 21, 2010

(54) METHOD OF MANUFACTURING PLASMA DISPLAY PANEL

(76) Inventors: Masashi Morita, Osaka (JP); Haruhiro Yuki, Osaka (JP); Kazuhiro Yokota, Hyogo (JP); Seiji Nishitani, Kyoto (JP); Satoshi Maeshima, Hyogo (JP)

Correspondence Address: WENDEROTH, LIND & PONACK L.L.P., 1030 15th Street, N.W., Suite 400 East, Washington, DC, 20005-1503, US

(21) Appl. No.: 12/524,463

(22) PCT Filed: Mar. 10, 2009
(86) PCT No.: PCT/JP2009/001052

§ 371 Date: Jul. 24, 2009

(30) Foreign Application Priority Data
Mar. 12, 2008 (JP) 2008-062162

(51) Int. Cl. H01J 11/02

(52) U.S. Cl. 427/71

(57) ABSTRACT

Provided is a method of manufacturing a plasma display panel including: a front plate on which a protective layer is formed on a dielectric layer, and a rear plate which is arranged to face the front plate so as to form a discharge space and on which a barrier rib for partitioning the discharge space is provided, wherein the protective layer of the front plate is formed by depositing an underlying film on the dielectric layer, coating a volatile solvent, in which aggregated particles obtained by aggregating a plurality of crystal particles including metal oxide are dispersed, on the underlying film, performing reduced-pressure drying, and attaching the aggregated particles to the underlying film.

### TECHNICAL FIELD

The present invention relates to a method of manufacturing a plasma display panel used in a display device or the like.

### BACKGROUND ART

A plasma display panel (hereinafter, referred to as a PDP) is commercialized as a 65-inch television or the like because a higher definition and a large screen can be realized. Recently, the PDP is being applied to a high-definition television in which the number of scan lines is at least twice that of a conventional NTSC method, and a PDP which does not include a lead component is required in consideration of an environmental problem.

The PDP basically includes a front plate and a rear plate. The front plate includes a glass substrate made of borosilicate sodium glass using a float process, a display electrode including a bus electrode and a transparent electrode having a stripe shape and formed on one main surface of the glass substrate, a dielectric layer covering the display electrode and functioning as a capacitor, and a magnesium oxide (MgO) protective layer formed on the dielectric layer. The rear plate includes a glass substrate, an address electrode having a stripe shape and formed on one main surface of the glass substrate, an underlying dielectric layer covering the address electrode, barrier ribs formed on the underlying dielectric layer, and phosphor layers formed between the barrier ribs and emitting lights of red, green and blue.

The front plate and the rear plate are hermetically sealed such that the electrode forming surfaces thereof face each other and discharge gas of Ne—Xe is enclosed in a discharge space partitioned by the barrier ribs at a pressure of 400 Torr to 600 Torr. The PDP realizes a color image display by selectively applying an image signal voltage to the display electrode so as to perform discharge, exciting the phosphor layers having the colors by ultraviolet rays generated by the discharge, and emitting lights of red, green and blue (see Patent Document 1).

[Patent Document 1] Japanese Patent Unexamined Publication No. 2007-48733

### DISCLOSURE OF THE INVENTION

There is provided a method of manufacturing a plasma display panel including: a front plate on which a dielectric layer is formed so as to cover a display electrode formed on a substrate and a protective layer is formed on the dielectric layer; and a rear plate which is arranged to face the front plate so as to form a discharge space and on which an address electrode is formed in a direction crossing the display electrode and a barrier rib for partitioning the discharge space is provided, wherein the protective layer of the front plate is formed by depositing an underlying film on the dielectric layer, coating a volatile solvent, in which a plurality of crystal particles including metal oxide are dispersed, on the underlying film, and performing reduced-pressure drying, so that the plurality of the crystal particles are attached so as to be distributed over the entire surface thereof.

### BRIEF DESCRIPTION OF THE DRAWINGS

FIG. 1 is a perspective view showing the structure of a PDP according to an embodiment of the present invention.

FIG. 2 is a cross-sectional view showing the configuration of a front plate of the PDP according to the embodiment of the present invention.

FIG. 3 is an enlarged explanatory diagram of a protective layer portion of the PDP according to the embodiment of the present invention.

FIG. 4 is an enlarged explanatory diagram of aggregated particles in the protective layer of the PDP according to the embodiment of the present invention.

FIG. 5 is a characteristic diagram showing a cathode luminescence measurement result of crystal particles.

FIG. 6 is a characteristic diagram showing a result of examining a Vscn lighting voltage and electron emission characteristics in the PDP, in the result of experiments performed in order to explain the effect of the present invention.

FIG. 7 is a characteristic diagram showing a relationship between the diameter of the crystal particles and the electron emission characteristics.

FIG. 8 is a characteristic diagram showing a relationship between the diameter of the crystal particles and a barrier rib breakdown generation rate.

FIG. 9 is a characteristic diagram showing an example of a particle size distribution of aggregated particles in the PDP according to the embodiment of the present invention.

FIG. 10 is a view showing a step of forming a protective layer in a method of manufacturing the PDP according to the embodiment of the present invention.

### DESCRIPTION OF REFERENCE NUMERALS AND SIGNS

1: PDP
2: front plate
3: front glass substrate
4: scan electrode
4a, 5a: transparent electrode
4b, 5b: metal bus electrode
5: sustain electrode
6: display electrode
7: black stripe (light shielding layer)
8: dielectric layer
9: protective layer
10: rear plate
11: rear glass substrate
12: address electrode
13: underlying dielectric layer
14: barrier rib
15: phosphor layer
16: discharge space
81: first dielectric layer
82: second dielectric layer
91: underlying film
92: aggregated particles
92a: crystal particles

### PREFERRED EMBODIMENTS FOR CARRYING OUT THE INVENTION

Ina PDP, a protective layer formed on a dielectric layer of a front plate has a function for protecting the dielectric layer from ion bombardment due to discharge and a function for emitting initial electrons for generating address discharge. The protection of the dielectric layer from the ion bombardment performs an important function for preventing a discharge voltage from being increased. The emission of the initial electrons for generating the address discharge performs an important function for preventing an address discharge error which causes flicker of an image.

In order to increase the number of initial electrons emitted from the protective layer so as to reduce the flicker of the image, for example, an attempt is made to add Si or Al to MgO.

Recently, high definition of television is processed and a full HD (High-Definition) (1920×1080 pixels: progressive display) PDP with low cost, low power consumption and high brightness is required in the market. Since the quality of the PDP is determined by the electron emission characteristics from the protective layer, it is very important to control the electron emission characteristics.

The present invention is contrived to solve such a problem and realizes a PDP having high-definition high-brightness display performance and low power consumption.

Hereinafter, the PDP according to an embodiment of the present invention will be described with reference to the drawings.

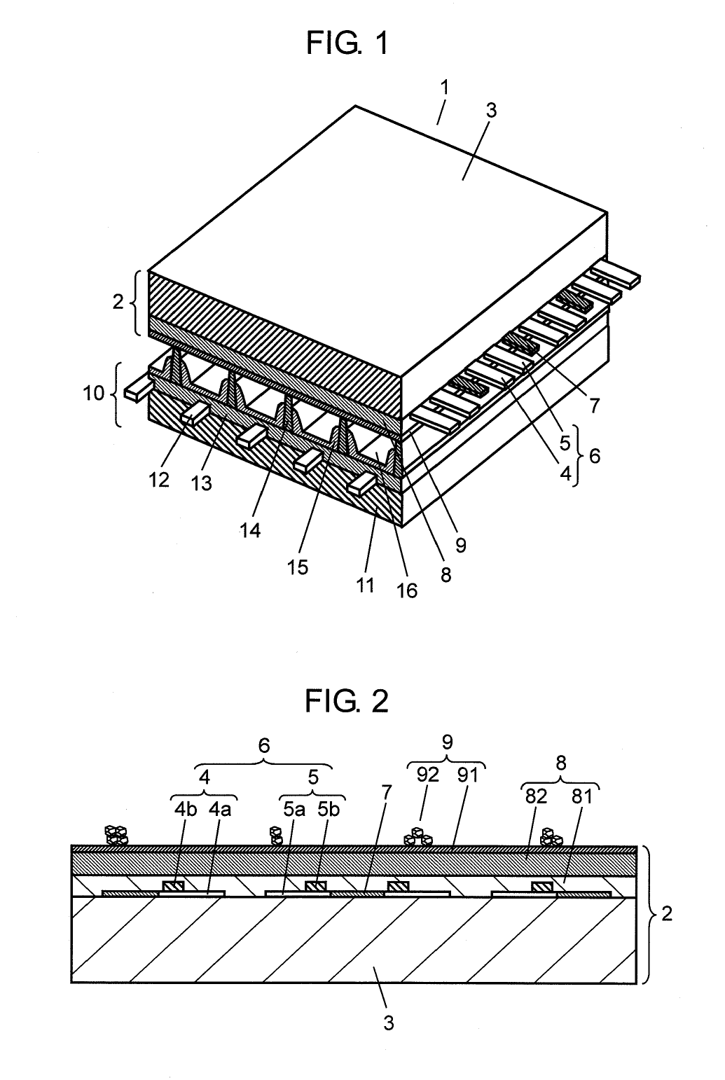

FIG. 1 is a perspective view showing the structure of a PDP according to an embodiment of the present invention. The basic structure of the PDP is equal to that of a general alternating current surface discharge type PDP. As shown in FIG. 1, in PDP 1, front plate 2 including front glass substrate 3 and so on and rear plate 10 including rear glass substrate 11 and so on are arranged to face each other, and the outer circumferences thereof are hermetically sealed by a sealing material formed of glass frit or the like. In discharge space 16 in sealed PDP 1, a discharge gas such as Ne, Xe and so on is enclosed at a pressure of 400 Torr to 600 Torr.

On front glass substrate 3 of front plate 2, a pair of band-shaped display electrodes 6 formed of scan electrode 4 and sustain electrode 5 and black stripes (light shielding layers) 7 are arranged in parallel in a plurality of rows. Dielectric layer 8 functioning as a capacitor is formed on front glass substrate 3 so as to cover display electrodes 6 and light shielding layers 7, and protective layer 9 formed of magnesium oxide (MgO) and the like is formed on the surface of dielectric layer 8.

On rear glass substrate 11 of rear plate 10, a plurality of band-shaped address electrodes 12 are arranged in parallel in a direction crossing scan electrodes 4 and sustain electrodes 5 of front plate 2, and underlying dielectric layer 13 covers address electrodes 12. Barrier ribs 14 having a predetermined height and partitioning discharge space 16 are formed on underlying dielectric layer 13 between address electrodes 12. Phosphor layers 15 for emitting lights of red, green and blue by ultraviolet rays are sequentially coated and formed in every address electrode 12 in grooves between barrier ribs 14. Discharge cells are formed at positions where scan electrodes 4 and sustain electrodes 5 and address electrodes 12 cross each other, and the discharge cells having phosphor layers 15 of red, green and blue arranged in the direction of display electrodes 6 form a pixel for a color display.

FIG. 2 is a cross-sectional view showing the configuration of front plate 2 of PDP 1, according to the embodiment of the present invention. FIG. 2 shows the vertically reversed state of FIG. 1. As shown in FIG. 2, display electrodes 6 including scan electrodes 4 and sustain electrodes 5 and light shielding layers 7 are patterned on front glass substrate 3 manufactured by a float process or the like. Scan electrodes 4 and sustain electrodes 5 include transparent electrodes 4a and 5a formed of indium tin oxide (ITO) or tin oxide (SnO₂) or the like and metal bus electrodes 4b and 5b formed on transparent electrodes 4a and 5a. Metal bus electrodes 4b and 5b are used to impart electric conductivity in a longitudinal direction of transparent electrodes 4a and 5a, and are formed of a conductive material mainly including a silver (Ag) material.

Dielectric layer 8 includes at least two layers including first dielectric layer 81 provided so as to cover transparent electrodes 4a and 5a, metal bus electrodes 4b and 5b and light shielding layers 7 formed on front glass substrate 3 and second dielectric layer 82 formed on first dielectric layer 81. In addition, protective layer 9 is formed on second dielectric layer 82. Protective layer 9 includes underlying film 91 formed on dielectric layer 8 and aggregated particles 92 attached onto underlying film 91.

Next, a method of manufacturing the PDP will be described. First, scan electrodes 4, sustain electrodes 5 and light shielding layers 7 are formed on front glass substrate 3. Transparent electrodes 4a and 5a and metal bus electrodes 4b and 5b are patterned using a photolithography method or the like. Transparent electrodes 4a and 5a are formed using a thin film process or the like, and metal bus electrodes 4b and 5b are solidified by firing a paste including the silver (Ag) material at a predetermined temperature. Light shielding layer 7 is also formed by forming a paste including a black pigment by a screen printing method or forming a black pigment on the entire surface of the glass substrate, patterning it using a photolithography method and firing it.

Next, a dielectric paste layer (dielectric material layer) is formed by coating a dielectric paste on front glass substrate 3 by a die coat method so as to cover scan electrodes 4, sustain electrodes 5 and light shielding layers 7. By coating the dielectric paste and leaving the dielectric paste for a predetermined time, the surface of the coated dielectric paste is leveled so as to form a flat surface. Thereafter, the dielectric paste layer is fired and solidified such that dielectric layer 8 covering scan electrodes 4, sustain electrodes 5 and light shielding layers 7 is formed. The dielectric paste is a pigment including a dielectric material such as glass powder, a binder and a solvent. Next, protective layer 9 formed of magnesium oxide (MgO) is formed on dielectric layer 8 by a vacuum deposition method. By the above-described steps, predetermined compositions (scan electrodes 4, sustain electrodes 5, light shielding layers 7, dielectric layer 8 and protective layer 9) are formed on front glass substrate 3 such that front plate 2 is completed.

Rear plate 10 is formed as follows. Firstly, a metal film is formed on the surface of rear glass substrate 11 by forming a paste including the silver (Ag) material by a screen printing method or the like, and a material layer which is a composition for address electrodes 12 is formed by a patterning method using a photolithography method. Thus, the material layer is fired at a predetermined temperature such that address electrodes 12 are formed. Secondly, a dielectric paste is coated on rear glass substrate 11, on which address electrodes 12 are formed, by a die coat method so as to cover address electrodes 12 such that a dielectric paste layer is formed. Thereafter, underlying dielectric layer 13 is formed by firing the dielectric paste layer. The dielectric paste is a pigment including a dielectric material such as glass powder, a binder and a solvent.

Finally, barrier ribs 14 are formed by coating a barrier rib forming paste including a barrier rib material on underlying dielectric layer 13, patterning the paste in a predetermined shape to forming a barrier rib material layer and by firing it. As a method of patterning the barrier rib forming paste coated on underlying dielectric layer 13, a photolithography method or a sand blast method may be used. Next, a phosphor paste including a phosphor material is coated on the side surfaces of barrier ribs 14 and on underlying dielectric layer 13 between adjacent barrier ribs 14 and is fired so as to form phosphor layers 15. By the above-described steps, rear plate 10 having predetermined components on rear glass substrate 11 is completed.

Front plate 2 and rear plate 10 including predetermined components are arranged such that scan electrodes 4 and address electrodes 12 face each other in a direction crossing each other, the peripheries thereof are sealed by glass frit, and discharge gas including Ne, Xe and so on is enclosed in discharge space 16, thereby completing PDP 1.

Here, first dielectric layer 81 and second dielectric layer 82 configuring dielectric layer 8 of front plate 2 will be described in detail. The dielectric material of first dielectric layer 81 includes the following material compositions, that is, 20 wt % to 40 wt % of bismuth oxide (Bi₂O₃), 0.5 wt % to 12 wt % of at least one selected from calcium oxide (CaO), strontium oxide (SrO) and barium oxide (BaO) and 0.1 wt % to 7 wt % of at least one selected from molybdenum oxide (MoO₃), tungsten oxide (WO₃), cerium oxide (CeO₂) and manganese dioxide (MnO₂).

Instead of molybdenum oxide (MoO₃), tungsten oxide (WO₃), cerium oxide (CeO₂) and manganese dioxide (MnO₂), 0.1 wt % to 7 wt % of at least one selected from copper oxide (CuO), chrome oxide (Cr₂O₃), cobalt oxide (Co₂O₃), vanadium oxide (V₂O₇) and antimony oxide (Sb₂O₃) may be included.

As other components, material compositions which do not include a lead component, such as 0 wt % to 40 wt % of zinc oxide (ZnO), 0 wt % to 35 wt % of boron oxide (B₂O₃), 0 wt % to 15 wt % of silicon oxide (SiO₂), 0 wt % to 10 wt % of aluminum oxide (Al₂O₃) and so on may be included, and the contents of the material compositions are not specially limited.

The dielectric material formed of these compositions is pulverized by a wet jet mill or a ball mill such that the average diameter thereof becomes 0.5 μm to 2.5 μm, and thus dielectric material powder is manufactured. Next, 55 wt % to 70 wt % of dielectric material powder and 30 wt % to 45 wt % of a binder component are kneaded by three rolls such that a paste for a first dielectric layer for die coat or printing is manufactured.

The binder component is butylcarbitolacetate or terpineol including 1 wt % to 20 wt % of ethylcellulose or arylic resin. In the paste for the first dielectric layer, if necessary, at least one of dioctyl phthalate, dibutyl phthalate, triphenyl phosphate and tributyl phosphate may be added as a plasticizing agent and at least one of glycerol monooleate, sorbitan sesquioleate, Homogenol (name of a product manufactured by Kao Corporation), an alkylallyl phosphate and so on may be added as a dispersing agent, thereby improving a printing property.

Next, the paste for the first dielectric layer is printed on front glass substrate 3 by a die coat method or a screen printing method so as to cover display electrode 6, is dried, and is fired at a temperature of 575° C. to 590° C., which is slightly higher than a softening temperature of the dielectric material.

Next, second dielectric layer 82 will be described. The dielectric material of second dielectric layer 82 is formed of the following material compositions. That is, the dielectric material of second dielectric layer 82 includes 11 wt % to 20 wt % of bismuth oxide (Bi₂O₃), 1.6 wt % to 21 wt % of at least one selected from calcium oxide (CaO), strontium oxide (SrO) and barium oxide (BaO), and 0.1 wt % to 7 wt % of at least one selected from molybdenum oxide (MoO₃), tungsten oxide (WO₃), and cerium oxide (CeO₂).

The dielectric material of second dielectric layer 82 may include 0.1 wt % to 7 wt % of at least one selected from copper oxide (CuO), chrome oxide (Cr₂O₃), cobalt oxide (Co₂O₃), vanadium oxide (V₂O₇), antimony oxide (Sb₂O₃) and manganese oxide (MnO₂), instead of molybdenum oxide (MoO₃), tungsten oxide (WO₃) and cerium oxide (CeO₂).

As other components, material compositions which do not include a lead component, such as 0 wt % to 40 wt % of zinc oxide (ZnO), 0 wt % to 35 wt % of boron oxide (B₂O₃), 0 wt % to 15 wt % of silicon oxide (SiO₂), 0 wt % to 10 wt % of aluminum oxide (Al₂O₃) and so on may be included, and the contents of the material compositions are not specially limited.

The dielectric material formed of these compositions are pulverized by a wet jet mill or a ball mill such that the average diameter thereof becomes 0.5 μm to 2.5 μm, and thus dielectric material powder is manufactured. Next, 55 wt % to 70 wt % of dielectric material powder and 30 wt % to 45 wt % of a binder component are kneaded by three rolls such that a paste for a second dielectric layer for die coat or printing is manufactured. The binder component is butylcarbitolacetate or terpineol including 1 wt % to 20 wt % of ethylcellulose or arylic resin. In the paste for the second dielectric layer, if necessary, dioctyl phthalate, dibutyl phthalate, triphenyl phosphate and tributyl phosphate may be added as a plasticizing agent and glycerol monooleate, sorbitan sesquioleate, Homogenol (name of a product manufactured by Kao Corporation), an alkylallyl phosphate and so on may be added as a dispersing agent, thereby improving a printing property.

Next, the paste for the second dielectric layer is printed on first dielectric layer 81 by a die coat method or a screen printing method, is dried, and is fired at a temperature of 550° C. to 590° C., which is slightly higher than a softening temperature of the dielectric material.

The film thickness of dielectric layer 8 is preferably 41 μm or less in order to secure visible light transmittance by combining first dielectric layer 81 and second dielectric layer 82. The content of bismuth oxide (Bi₂O₃) of first dielectric layer 81 is 20 wt % to 40 wt % which is larger than that of bismuth oxide (Bi₂O₃) of second dielectric layer 82, in order to suppress reaction with silver (Ag) of metal bus electrodes 4b and 5b. Accordingly, since the visible light transmittance of first dielectric layer 81 is lower than that of second dielectric layer 82, the film thickness of first dielectric layer 81 is smaller than that of second dielectric layer 82.

If the content of bismuth oxide (Bi₂O₃) of second dielectric layer 82 is 11 wt % or less, coloring is hard to be generated, but bubbles are unpreferably apt to be generated in second dielectric layer 82. If the content of bismuth oxide (Bi₂O₃) of first dielectric layer 81 exceeds 40 wt %, coloring is apt to be generated and is not preferable in view of the purpose to increase transmittance.

Since the effects such as the improvement of panel brightness and the reduction of the discharge voltage are increased as the film thickness of the dielectric layer 8 is decreased, it is preferable that the film thickness is as small as possible in a range in which an insulation voltage is not decreased. From this viewpoint, in the embodiment of the present invention, the film thickness of dielectric layer 8 is set to 41 μm or less, the film thickness of first dielectric layer 81 is set to 5 μm to 15 μm, and the film thickness of second dielectric layer 82 is set to 20 μm to 36 μm.

In the PDP manufactured by the above-described method, a coloring phenomenon (yellowing) of front glass substrate 3 rarely occurs and bubbles are not generated in dielectric layer 8 even when the silver (Ag) material is used in display electrode 6. Accordingly, it is possible to realize dielectric layer 8 with excellent performance with respect to the insulation voltage.

Next, in the PDP according to the embodiment of the present invention, the reason why yellowing or the generation of bubbles is suppressed in first dielectric layer 81 by these dielectric materials will be considered. It is known that a compound such as Ag₂MoO₄, Ag₂Mo₂O₇, Ag₂Mo₄O₁₃, Ag₂WO₄, Ag₂W₂O₇ or Ag₂W₄O₁₃ is apt to be generated at a low temperature of 580° C. or less by adding molybdenum oxide (MoO₃) or tungsten oxide (WO₃) to the dielectric glass including bismuth oxide (Bi₂O₃). In the embodiment of the present invention, since the firing temperature of dielectric layer 8 is 550° C. to 590° C., a silver ion (Ag⁺) spread into dielectric layer 8 during firing reacts with molybdenum oxide (MoO₃), tungsten oxide (WO₃), cerium oxide (CeO₂) and manganese oxide (MnO₂) in dielectric layer 8, and a stable compound is generated and stabilized. That is, since the silver ion (Ag⁺) is stabilized without being reduced, the colloid is not generated by aggregation. Accordingly, since the generation of oxygen due to colloidalization of silver (Ag) is suppressed by stabilizing the silver ion (Ag⁺), the generation of bubbles in dielectric layer 8 is also suppressed.

In order to validate these effects, the content of molybdenum oxide (MoO₃), tungsten oxide (WO₃), cerium oxide (CeO₂) and manganese oxide (MnO₂) in the dielectric glass including bismuth oxide (Bi₂O₃) is preferably 0.1 wt % or more and more preferably from 0.1 wt % to 7 wt %. In particular, if the content is less than 0.1 wt %, the effect of suppressing yellowing is reduced and, if the content exceeds 7 wt %, coloring is unpreferably generated in glass.

That is, dielectric layer 8 of the PDP according to the embodiment of the present invention suppresses the yellowing phenomenon and the generation of bubbles in first dielectric layer 81 which is in contact with metal bus electrodes 4b and 5b formed of the silver (Ag) material. Dielectric layer 8 realizes high light transmittance by second dielectric layer 82 formed on first dielectric layer 81. As a result, bubbles or yellowing are rarely generated in whole dielectric layer 8, and thus enabling the PDP with high transmittance to be realized.

Next, the configuration of the protective layer, which is the feature of the PDP according to the embodiment of the present invention, and the method of manufacturing the protective layer will be described.

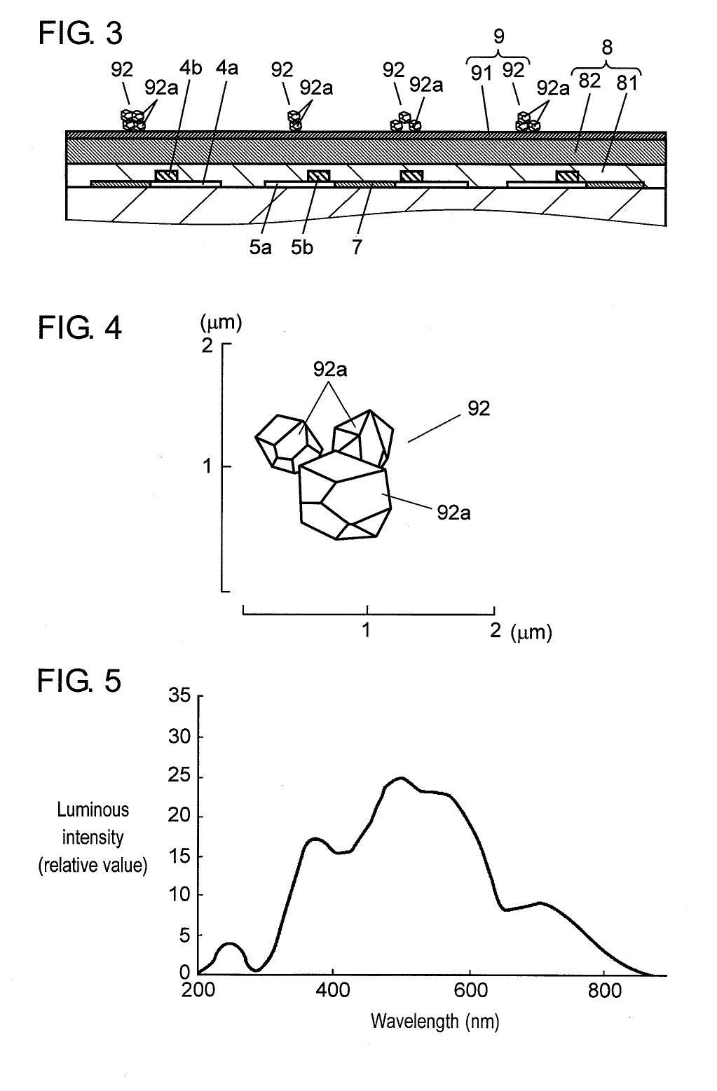

In the PDP according to the embodiment of the present invention, as shown in FIG. 3, protective layer 9 is formed by forming underlying film 91 formed of MgO containing Al as impurities on dielectric layer 8 and discretely dispersing aggregated particles 92 obtained by aggregating several crystal particles 92a of MgO, which is metal oxide, on underlying film 91 such that the aggregated particles are substantially uniformly distributed and attached over the entire surface thereof.

Aggregated particles 92 indicate particles in which crystal particles 92a having a predetermined primary diameter are aggregated or necked, as shown in FIG. 4. Particles are not bonded with high binding force as a solid, but a plurality of primary particles form a body of an aggregate by static electricity, Van der Waals' force or the like, and a portion or all particles is bonded by an external stimulus such as ultrasonic waves so as to become a primary particle state. It is preferable that the diameter of aggregated particles 92 is about 1 μm and crystal particles 92a have the shape of a polyhedron having at least seven faces, such as a dodecahedron or a tetradecahedron.

The diameter of the primary particles of crystal particles 92a of MgO can be controlled by a generation condition of crystal particles 92a. For example, if the crystal particles are generated by firing a precursor of MgO, such as magnesium carbonate or magnesium hydroxide, the diameter can be controlled by controlling a firing temperature or a firing atmosphere. Generally, the firing temperature may be selected in a range from about 700° C. to about 1500° C., but the primary diameter can be controlled to be about 0.3 to 2 μm by setting the firing temperature to a relatively high temperature of 1000° C. or more. By heating the precursor of MgO so as to obtain crystal particles 92a, in the generating process, it is possible to obtain aggregated particles 92 in which the plurality of primary particles are bonded by a phenomenon called aggregation or necking.

Next, an experimental result for confirming the effects of the PDP having the protective layer according to the embodiment of the present invention will be described.

First, PDPs having protective layers which are different in the configuration were experimentally manufactured. Prototype 1 is a PDP in which only a protective layer using MgO is formed. Prototype 2 is a PDP in which a protective layer using MgO, into which impurities such as Al, Si or the like are doped, is formed. Prototype 3 is a PDP in which only primary particles of crystal particles formed of metal oxide are sprayed and attached onto a protective layer using MgO. Prototype 4 is a PDP in which a crystal particle paste including aggregated particles and a dispersing solvent is coated on underlying film 91 using MgO as described above so as to form a crystal particle paste film, and the underlying film and the crystal particle paste film are then fired such that the aggregated particles obtained by aggregating the crystal particles are substantially uniformly distributed and attached over the entire surface thereof, as the product of the present invention. The aggregated particles are obtained by aggregating a plurality of crystal particles formed of metal oxide. The dispersing solvent is a solvent for dispersing the aggregated particles and is classified into any one of an aliphatic alcohol solvent having an ether bond or a di- or higher valent alcohol solvent. In prototypes 3 and 4, single crystal particles of MgO are used as metal oxide. As a result of measuring cathode luminescence with respect to the crystal particles used in prototype 4 according to this embodiment, the characteristics of luminous intensity to the wavelength shown in FIG. 5 were obtained. The luminous intensity is represented by a relative value.

The electron emission performance and the charge holding performance of the PDPs having four kinds of protective layers were examined.

The electron emission performance is increased as the electron emission amount is increased, and is represented by an initial electron emission amount determined by a discharge surface state, kinds of gas, and the state of the gas. The initial electron emission amount may be measured by a method of irradiating ions or electron beams to a surface and measuring an electron current emitted from the surface, but the evaluation of the surface of the front plate of the panel in a non-destructive manner remains difficult. Accordingly, as described in Japanese Patent Unexamined Publication No. 2007-48733, of delay times of discharge, a value which is the standard of easiness in occurrence of discharge and is called a statistical delay time of a discharge delay time is measured. A value linearly corresponding to an initial electron emission amount is calculated by integrating an inverse number of that value. Accordingly, the electron emission amount is evaluated using the calculated value. The discharge delay time indicates a discharge delay time in which the discharge is delayed from a rising edge of a pulse. It is considered that the discharge delay is caused mainly because initial electrons triggered when the discharge is started are hard to be emitted from the surface of the protective layer into the discharge space.

As the index of the charge holding performance, a value of a voltage (hereinafter, referred to as Vscn lighting voltage) applied to the scan electrodes and necessary for suppressing the charge emission phenomenon when the PDP is manufactured was used. That is, if the Vscn lighting voltage is small, the charge holding performance is high. Since the PDP can be driven at a low voltage in the design of the panel, a component having a small insulation voltage and capacity can be used as a power supply or an electrical part. In a current product, an element having an insulation voltage of about 150 V is used in a semiconductor switching element, such as a MOSFET or the like, for sequentially applying the scan voltage to the panel. Accordingly, the Vscn lighting voltage is preferably suppressed to 120 V or less in consideration of a variation in temperature.

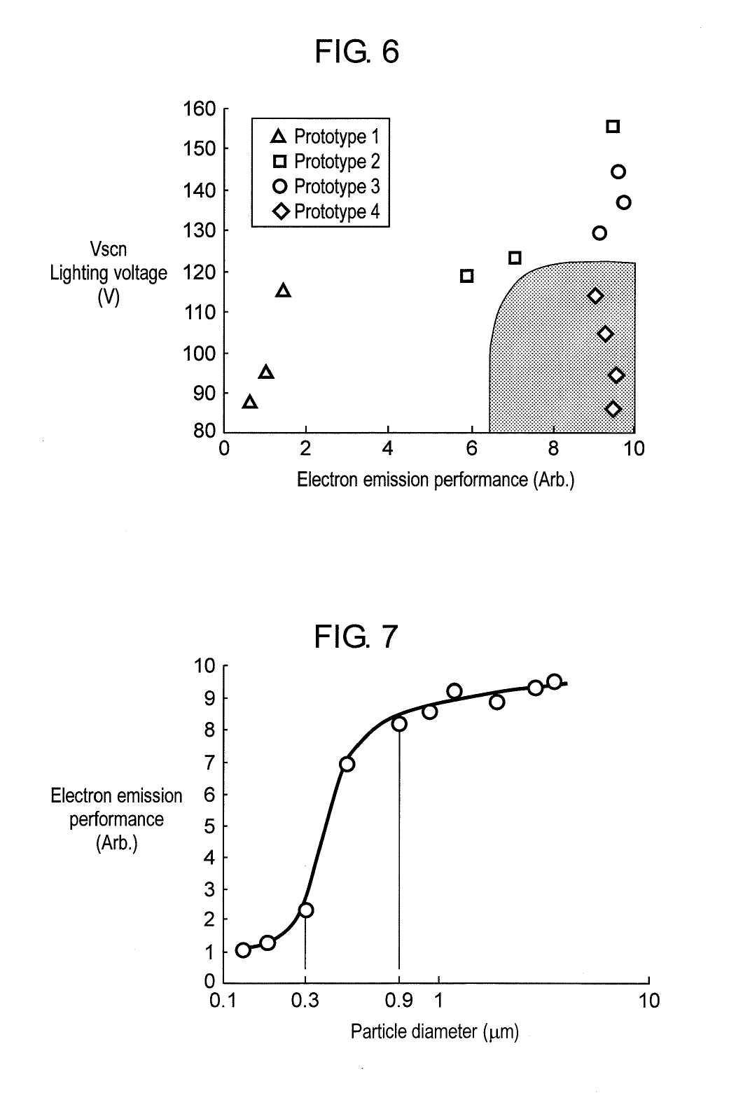

FIG. 6 shows a result of examining the electron emission performance and the charge holding performance. It can be seen from FIG. 6 that prototype 4 has good characteristics that the Vscn lighting voltage may be set to 120 V or less in the evaluation of the charge holding performance and the electron emission performance is 6 or more.

That is, generally, the electron emission performance and the charge holding performance of the protective layer of the PDP are in tradeoff. For example, by changing a film forming condition of the protective layer or doping impurities Al, Si, Ba or the like into the protective layer so as to form the film, the electron emission performance can be improved, but the Vscn lighting voltage is also increased as an adverse effect.

In the PDP on which protective layer 9 is formed according to the embodiment of the present invention, the electron emission performance is 6 or more and the Vscn lighting voltage is 120 V or less as the charge holding performance. Accordingly, both the electron emission performance and the charge holding performance can be satisfied with respect to the protective layer of the PDP in which the number of scan lines is increased with high definition, and a cell size tends to be decreased.

Next, the diameter of the crystal particles used in protective layer 9 of the PDP according to the embodiment of the present invention will be described. In the following description, the particle diameter indicates an average particle diameter, and the average particle diameter indicates a volume cumulative average diameter (D50).

FIG. 7 shows an experimental result of examining the electron emission performance by changing the diameter of the crystal particles of MgO in prototype 4 of the present invention described with reference to FIG. 6. In FIG. 7, the diameter of the crystal particles of MgO was measured by observing the crystal particles using a SEM.

As shown in FIG. 7, it can be seen that, if the particle diameter is decreased to about 0.3 μm, the electron emission performance is decreased, and, if the particle diameter is substantially 0.9 μm or more, high electron emission performance is obtained.

In order to increase the electron emission number in the discharge cell, preferably a large number of crystal particles 92a per unit area on underlying film 91 is preferable. According to the experiments of the present inventors, when crystal particles 92a are present in a portion corresponding to a top part of barrier rib 14 of rear plate 10 which is in close contact with protective layer 9 of front plate 2, the top part of barrier rib 14 may be broken down. It was found that the broken-down material which may be located on phosphor layer 15 may cause a phenomenon that the cell is not normally turned on or off occurs. Since the barrier rib is hard to be broken down if the crystal particles are not present on the portion corresponding to the top part of the barrier rib, a barrier rib breakdown probability is increased if the number of crystal particles attached is increased.

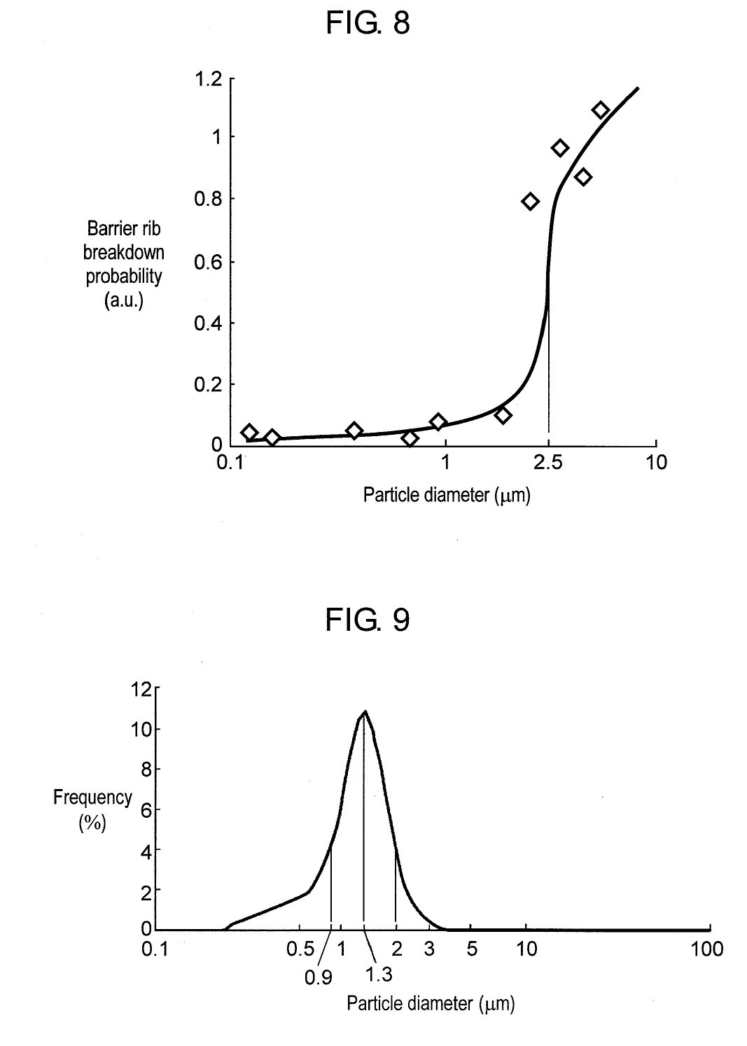

FIG. 8 is a diagram showing a result of dispersing the same number of crystal particles having different diameters per unit area of underlying film 91 and examining a barrier rib breakdown relationship, in prototype 4 of the embodiment of the present invention described with reference to FIG. 6.

It can be seen from FIG. 8 that, if the diameter of crystal particles is increased to about 2.5 μm, the barrier rib breakdown probability is significantly increased. However, it can be seen that, if the diameter of crystal particles is smaller than 2.5 μm, the barrier rib breakdown probability can be relatively suppressed.

Based the above-described result, in protective layer 9 of the PDP according to the embodiment of the present invention, the diameter of the crystal particles is preferably from 0.9 μm to 2.5 μm. However, if the PDP is actually mass produced, it is necessary to consider a manufacture deviation of crystal particles 92a or a manufacture deviation when protective layer 9 is formed.

In order to consider such manufacture deviation factors or the like, experiments were performed by changing the diameter of the crystal particles. FIG. 9 shows the diameters of the crystal particles and the present frequency of the crystal particles having the diameters as an example. In the example of the crystal particles shown in FIG. 9, it was found that if the crystal particles whose average diameter is in a range of 0.9 μm to 2 μm are used, the above-described effects of the present invention can be stably obtained.

As described above, in the PDP in which the protective layer is formed according to the present invention, the electron emission performance is 6 or more and the Vscn lighting voltage is 120 V or less as the charge holding performance. Accordingly, both the electron emission performance and the charge holding performance can be satisfied with respect to the protective layer of the PDP in which the number of scan lines is increased with high definition, and a cell size tends to be decreased. Accordingly, it is possible to realize a PDP having high-definition high-brightness display performance and low power consumption.

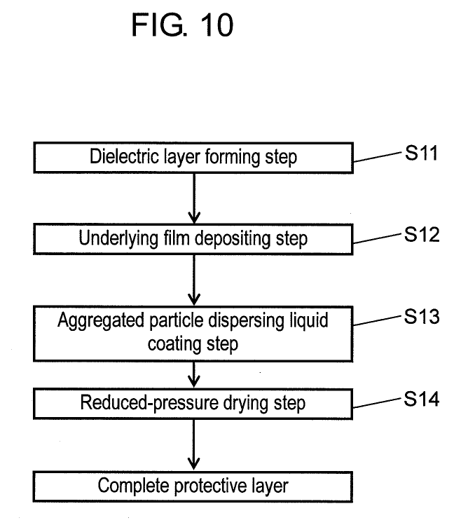

Next, a method of manufacturing the protective layer in the PDP according to the embodiment of the present invention will be described with reference to FIG. 10.

As shown in FIG. 10, dielectric layer forming step S11 of forming dielectric layer 8 including a lamination structure of first dielectric layer 81 and second dielectric layer 82 is performed. Thereafter, in next underlying film depositing step S12, underlying film formed of MgO is formed on second dielectric layer 82 of dielectric layer 8 by a vacuum deposition method using a sintered body of MgO including Al as a raw material.

Thereafter, aggregated particle paste film forming step S13 of discretely attaching a plurality of aggregated particles on the unfired underlying film formed in underlying film depositing step S12 is performed.

In aggregated particle paste film forming step S13, first, aggregated particles 92 having a predetermined diameter distribution are mixed to a volatile solvent so as to prepare an aggregated particle dispersing liquid. In aggregated particle dispersing liquid coating step S13, the aggregated particle dispersing liquid is coated on the unfired underlying film by a slit coater method or the like. As the method of coating the aggregated particle dispersing liquid on the unfired underlying film, a die coater method, a table coater method, a curtain coater method or the like may be used in addition to the slit coater method.

Thereafter, in reduced-pressure drying step S14, only a volatile solvent of the aggregated particle dispersing liquid coated on underling film 91 is dried. In this way, protective layer 9 in which a plurality of aggregated particles 92 are attached onto underlying film 91 can be formed. It is preferable that a reduced-pressure drier has an ultimate vacuum degree equal to or less than vapor pressure of the used volatile solvent, and an exhausting direction thereof equal to the substrate.

According to this method, it is possible to attach the plurality of aggregated particles 92 on underlying film 91 such that the aggregated particles are substantially uniformly distributed over the entire surface thereof. Since a resin component, a surfactant or the like is not required as a coating liquid, an organic component does not need to be burned by a firing step or the like in addition to reduced-pressure drying step S14, and thus protective layer 9 can be more simply formed.

Although, in the above description, for example, MgO is used for protective layer 9, performance required for the underlying film is to have high sputter resistance performance for protecting a dielectric layer from ion bombardment, and high charge holding performance, that is, high electron emission performance, is not necessarily required. In the conventional PDP, in order to make both at least predetermined electron emission performance and sputter resistance performance compatible, there were frequent occasions when a protective layer including MgO as a main component is formed. However, since in the invention, electron emission performance is dominantly controlled by metal oxide single crystal particles, MgO is not necessarily used for the protective layer, and other materials with excellent impact resistance, such as Al₂O₃, may be used.

Although, in the embodiment of the present invention, MgO particles are used as single crystal particles, since the same effects can be obtained even when other single crystal particles, that is, crystal particles using metal oxide, such as Sr, Ca, Ba or Al having high electron emission performance similar to MgO, are used, the kinds of particle is not limited to MgO.

In the conventional PDP, electron emission characteristics were tried to be improved by mixing impurities to the protective layer. However, if the electron emission characteristics are improved by mixing the impurities to the protective layer, charges are also accumulated on the surface of the protective layer and thus a reduction rate that charges to be used as a memory function are reduced with time is increased. Accordingly, a countermeasure such as the increase of an applied voltage for suppressing the increase of the reduction rate is necessary. Thus, the conventional PDP has a problem that the characteristics of the protective layer should include two characteristics in tradeoff, high electron emission performance and the decrease of the reduction rate of the charges as the memory function, that is, high charge holding characteristics.

On the other hand, according to the present invention, as described above, it is possible to provide a PDP with improved electron emission performance and charge holding performance, high quality, low cost and a low voltage. Accordingly, it is possible to realize a PDP having high-definition high-brightness display performance and low power consumption.

According to the manufacturing method of the present invention, it is possible and more simply to attach a plurality of crystal particles on an underlying film such that the crystal particles are substantially uniformly distributed over the entire surface thereof.

### INDUSTRIAL AVAILABILITY

As described above, the present invention is used to realize a PDP having high-definition high-brightness display performance and low power consumption.

1. A method of manufacturing a plasma display panel comprising:
a front plate on which a dielectric layer is formed so as to cover a display electrode formed on a substrate and a protective layer is formed on the dielectric layer; and
a rear plate which is arranged to face the front plate so as to forma discharge space and on which an address electrode is formed in a direction crossing the display electrode and a barrier rib for partitioning the discharge space is provided,
wherein the protective layer of the front plate is formed by depositing an underlying film on the dielectric layer,
coating a volatile solvent, in which a plurality of crystal particles including metal oxide are dispersed, on the underlying film, and
performing reduced-pressure drying, so that the plurality of crystal particles are attached so as to be distributed over the entire surface thereof.

2. The method of claim 1,
wherein the coating of the volatile solvent in which the crystal particles are dispersed is performed by a coating method of a coater system having a die head.

3. The method of claim 1,
wherein the crystal particles are aggregated particles obtained by aggregating the plurality of crystal particles including metal oxide.
